(19) United States
(12) Patent Application Publication
(10) Pub. No.: US 2008/0289000 A1
(43) Pub. Date: Nov. 20, 2008

(54) METHOD AND ELECTRONIC DEVICE FOR MANAGING APPLICATIONS

(75) Inventors: Hoi L. Young, Lake Villa, IL (US); William F. Zancho, Hawthorn Woods, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/749,197

(22) Filed: May 16, 2007

(51) Int. Cl. H04L 9/00

(52) U.S. Cl. 726/1

(57) ABSTRACT

The present invention provides a method for managing an application at an electronic device (202). The method includes receiving (304) the application at the electronic device. The application has one or more user interface attributes. Each user interface attribute has a set of usable values. The method also includes determining (306) a set of permitted values of at least one of the one or more user interface attributes by using policy rules in response to one or more environmental conditions determined by the electronic device. Further, the method includes merging (308) the application with an operational platform of the electronic device and activating the application. The application is merged and activated at the electronic device, when, for each of the at least one of the one or more user interface attributes of the application, there is at least one value that is common to the set of permitted values and the set of usable values.

The present invention generally relates to electronic devices, and more particularly, to a method and system for managing applications at an electronic device.

### BACKGROUND OF THE INVENTION

Electronic devices are important tools for storing, transmitting and receiving data. The electronic device can be a communication device, a computing device or a home appliance. Some examples of such electronic devices include mobile phones, smart phones, laptops, personal computers, interactive TVs, interactive music players, and Personal Digital Assistants (PDAs). These electronic devices can be connected to each other via a communication network. Examples of the communication network include the Internet, a Public Switched Telephone Network (PSTN), a global Telecommunications Exchange (TELEX) network, a Global System for Mobile (GSM) network, a Code Division Multiple Access (CDMA) network, a Local Area Network (LAN), and so forth. The electronic devices can also be connected to each other via a direct connection such as Bluetooth®, infra-red, and so forth.

A connection between the electronic devices enables them to share data. The data can be associated with user preferences such as etiquettes, font types, and so forth. Examples of data can also include multimedia applications, video, voice, text, images, direct feeds, for example, mobile television, and so forth. Other examples would include user interaction preference data as well as device feature applications and various service applications. In some cases, the data may not be compatible with the hardware and/or software at the electronic device. This could prevent transfer and/or use of data at the electronic device.

There are various methods that enable the transfer and/or use of incompatible data at the electronic device. One such method involves configuring the data in such a manner that it is compatible with the hardware and/or software at the electronic device. In this method, data is received at the electronic device, and the compatibility of this data is checked with the hardware and/software at the electronic device. Data that is incompatible with the electronic device is modified according to the hardware and/or software capabilities of the electronic device. As a result, the data can be configured and used at the electronic device.

In this method, the data is configured according to the hardware and/or software capabilities of the electronic device. However, this data is not checked for its compatibility with user requirements, policies, etiquette, laws, cultures and/or environmental conditions such as the location including vehicles, theaters, homes, offices/enterprise, etc. and the time at the electronic device. Further, applications that are accepted at the electronic device are not monitored for their compatibility with user requirements and/or environmental conditions at the electronic device, since user requirements and/or environmental conditions may change. Moreover, accepted applications that become incompatible with user requirements and/or environmental conditions at the electronic device are not removed from the device.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary connection between a first electronic device and a second electronic device, in accordance with certain embodiments of the present invention;

FIG. 2 illustrates an electronic device, in accordance with certain embodiments of the present invention;

FIG. 3 is a flow diagram illustrating some steps of a method for managing applications at a electronic device, in accordance with certain embodiments of the present invention; and

FIGS. 4 and 5 are flow diagrams illustrating some steps of a method for managing applications at an electronic device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for managing applications at an electronic device, in accordance with various embodiments of the present invention, it should be observed that the present invention resides primarily in combinations of method steps related to the method and system for managing applications at the electronic device. Accordingly, the system components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms ‘comprises,’ ‘comprising’, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by ‘comprises . . . a’ does not, without more constraints, preclude the existence of additional identical elements in the process, method, article or apparatus that comprises the element. The term “another,” as used in this document, is defined as at least a second or more. The terms ‘includes’ and/or ‘having’, as used herein, are defined as comprising.

For one embodiment, a method for managing an application at an electronic device is provided. The method includes receiving the application at the electronic device. The application includes attributes that comprise one or more user interface attributes. Each attribute includes a set of usable values. The method also includes determining a set of permitted values of at least one of the one or more attributes of the application. The permitted values are determined by using policy rules, in response to one or more environmental conditions determined by the electronic device. Further, the method includes merging the application with the operational platform of the electronic device, and activating the application. The application is merged and activated at the electronic device when there is at least one value that is common to the set of permitted values and the set of usable values for each of the at least one of the one or more user interface attributes of the application. In some embodiments, merging may additionally require the same constraint for other attributes

For another embodiment, an electronic device that is capable of managing an application is provided. The electronic device includes a receiver that is configured to receive the application, which includes one or more. Each attribute includes a set of usable values. The electronic device also includes a processor that is configured to determine a set of permitted values of at least one of the one or more attributes of the application. The permitted values are determined by using policy rules in response to one or more environmental conditions determined by the electronic device. Further, the processor is configured to merge the application with an operational platform of the electronic device and activate the application. The application is merged and activated at the electronic device, when there is at least one value that is common to the set of permitted values and the set of usable values for each of the at least one of the one or more user interface attributes of the application. In some embodiments, merging may additionally require the same constraint for other attributes

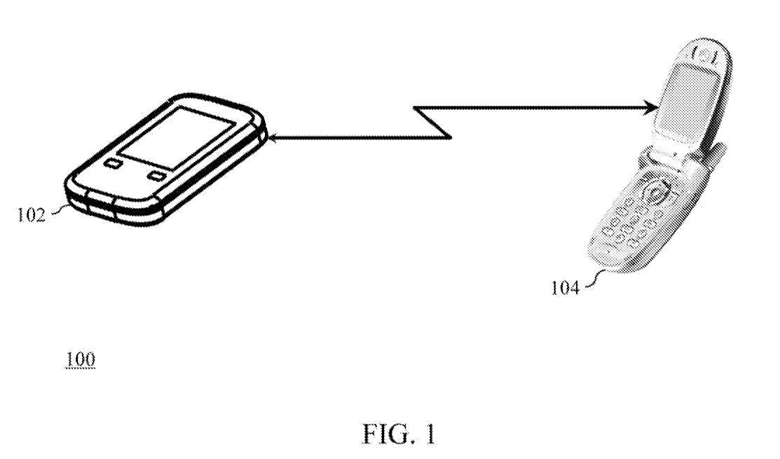

FIG. 1 illustrates an exemplary connection between a first electronic device 102 and a second electronic device 104, in accordance with an embodiment of the present invention. The first electronic device 102 and the second electronic device 104 can be a communication device, a computing device or an appliance. Examples of the communication device include, but are not limited to, a mobile phone, a smart phone, a laptop, a computer, a Personal Digital Assistant (PDA) and so forth. Examples of computing device include calculators, digital diaries, and so forth. Examples of appliances include an interactive TV, a music player, refrigerator and so forth. Although the first electronic device 102 and the second electronic device 104 are depicted as mobile phones, however, it will be apparent to any person ordinarily skilled in the art that the first electronic device 102 and the second electronic device 104 can be any other suitable electronic device where various embodiments of the present invention can be practiced. The first electronic device 102 and the second electronic device 104 can be connected to each other through a communication network such as the Internet, a Public Switched Telephone Network (PSTN), a global Telecommunications Exchange (TELEX) network, a Global System for Mobile (GSM) communication network, a Code Division Multiple Access (CDMA) network, a Local Area Network (LAN), and so forth. The electronic devices can also be connected to each other via a direct connection such as Bluetooth®, infrared, and so forth.

The first electronic device 102 can receive an application from the second electronic device 104. The application received at the first electronic device 102 can be a single media or multimedia application that, for example, manipulates voice data, video data, text data, images, and so forth. The first electronic device 102 can accept or reject the received application, based on the user interface attributes of the application, user preferences and the policy rules set at the first electronic device 102. For example, in a scenario, the application can be rejected at the electronic device when the device is in an area of strategic importance such as a defense area, where the use of any non-defense application is not permitted. In another scenario, the application can be rejected when the font of its text, a user attribute, does not match user requirements.

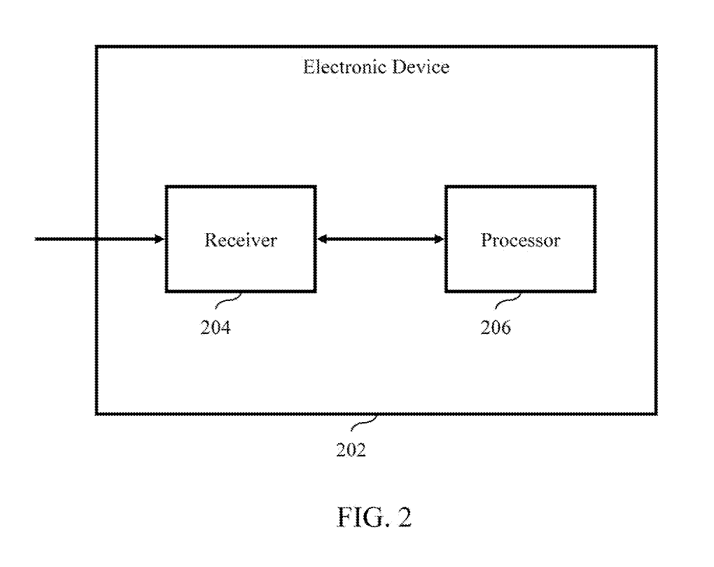

FIG. 2 illustrates an electronic device 202, in accordance with an embodiment of the present invention. The electronic device 202 can be a communication device, a computing device or a home appliance. An example of the electronic device 202 can be the first electronic device 102 described in FIG. 1. The electronic device 202 can receive an application from other electronic devices. After receiving the application, the electronic device 202 can merge or reject the application, based on the attributes of the application, user preferences, and the policy rules determined by the electronic device 202. To check whether the application can be merged at the electronic device 202, the values of the user interface attributes (and in some embodiments, other attributes) of the application, the permitted values and the usable values can be compared with each other at the time of transmittal of the application and at the time of receipt of the application at the electronic device 202. Merging the application implies acceptance of the application at the electronic device 202. The electronic device 202 includes a receiver 204 and a processor 206.

The receiver 204 can receive an application from other electronic devices. This application is received at the electronic device 202 to enable merging of the application at the electronic device 202. For example, the receiver 204 at the electronic device 202 can receive the price list application of the food served at a restaurant. The application includes one or more attributes. For example, the price list application can include certain user interface attributes such as format, platform dependency, user interface, the font of the text, and so forth. Each user attribute has a set of usable values. For example, user interface attributes such as the format of the price list application can be represented in terms of usable values such as ‘.txt’, ‘.doc’, and so forth. After the receiver 204 receives the application, the processor 206 determines whether the application can be merged and activated at the electronic device 202.

The processor 206 can determine a set of permitted values of at least one of the one or more user interface attributes. These values are the values that the application should adhere to, to enable merging of the application with the operational platform at the electronic device 202. The operational platform at the electronic device 202 can be an operating system. The permitted values are determined by using policy rules at the electronic device 202. These permitted values depend on the environmental conditions determined by the electronic device 202. For example, policy rules may define the permitted values of the location attribute of the application at the electronic device 202 as locations inside a restaurant. In that event, the application will be rejected when the electronic device 202 is outside the restaurant. Each policy rule can be of a source type that is legal, governmental, cultural, religious, a user's personal level of ethics, or a user's personal level of style, personality or practice, or commerce.

Further, the processor 206 can merge the application with an operational platform of the electronic device 202. This operational platform of the electronic device 202 can be an operating system that is located at the electronic device 202. Examples of the operational platform can include Microsoft® Windows® XP, Linux®, Mac® OS, Microsoft® Windows® Mobile, Symbian® OS, and so forth. The application is merged with an operational platform of the electronic device 202 when there is at least one value that is common to the set of permitted values and the set of usable values for each of the at least one of the one or more user interface attributes of the application. For example, the price list application of the application can be merged when the electronic device 202 is located inside the restaurant.

The processor 206 can also decide whether the merged application can be activated at the electronic device 202. Activation of the application at the electronic device 202 enables the use of the application at the electronic device 202. For example, if the touch-screen phone, which is located in a theatre, receives the voiced-icons, the touch-screen phone can merge the voiced-icon application but will not activate it until the touch-screen phone moves out of the theatre.

The processor 206 can also determine a desired value of the one or more user interface attributes of the application, which is based on the inputs of the user of the electronic device 202. For example, the user of the electronic device 202 can specify the font size of the text of the application, such as the price list application of the restaurant that should be allowed to merge with the electronic device 202. The application is merged with other applications at the electronic device 202 when there is at least one value that is common to the set of permitted values, the set of usable values, and the desired value for each of the at least one of the one or more user interface attributes of the application. For example, the price list application can be merged with other applications at the electronic device 202 when the font size of the text of the price list application is within the range mentioned by the user, and the electronic device 202 is located inside the restaurant.

The processor 206 monitors each application that is merged at the electronic device 202. When the application at the electronic device 202 temporarily loses its compatibility with the electronic device 202, the processor 206 de-activates the application at the electronic device 202. The compatibility of the application at the electronic device 202 is determined by using the permitted values, the usable values, and the desired values of the application, and circumstances relevant to the user and the user's environment as determined by the electronic device. For example, when the user moves temporarily out of the restaurant, the location attribute of the application at the electronic device 202 will not match the permitted values of the location, and the price list application of the restaurant will be de-activated at the electronic device 202. When the compatibility of the application at the electronic device 202 is restored, the processor 206 re-activates the application. For example, when the user re-enters the restaurant, the compatibility of the application at the electronic device 202 is restored and the price list application of the restaurant re-activated at the electronic device 202. In another example, there could be situations in which a camera application of an electronic device 202 is deactivated by a local signal provided at authorized locations (e.g, locker rooms, performance venues), and reactivated after leaving that location. When the compatibility of the application is permanently lost, the processor 206 purges the application. The compatibility of the application is permanently lost when the usable values, the desired values and the permitted values do not match beyond a set period of time. For example, when the electronic device moves out of the restaurant for a time which is more than a set period of time, the compatibility of the price list application would be permanently lost and the price list application can be purged at the electronic device 202.

Further, the compatibility of the application can also be permanently lost when the application is inactive for a pre-defined time period. Moreover, the compatibility of the application can also be permanently lost when there are some modifications in the application or the permitted values. For example, when the user returns to the restaurant and the price list application has changed, then the old price list application at the electronic device 202 can be purged and a new price-list application can be merged at the electronic device. For another example, a vehicle application may perform some functions that become illegal due to a Federal law, in which case the application could be purged from the electronic device. 202 because it can no longer be used. Purging the application implies that the installed instance of the application is unmerged from the electronic device 202; this means, for example, that that the installed instance of the application can no longer be used at the electronic device 202 and that the memory space the installed instance of the application occupied can be used for other purposes. Deactivating means that the application is not purged, but is prevented from performing one or more functions as defined by a policy rule. Reactivating can then be accomplished without remerging the application. In many emodiments, deactivating and reactivating are accomplished by changing a state or states of some stored parameters.

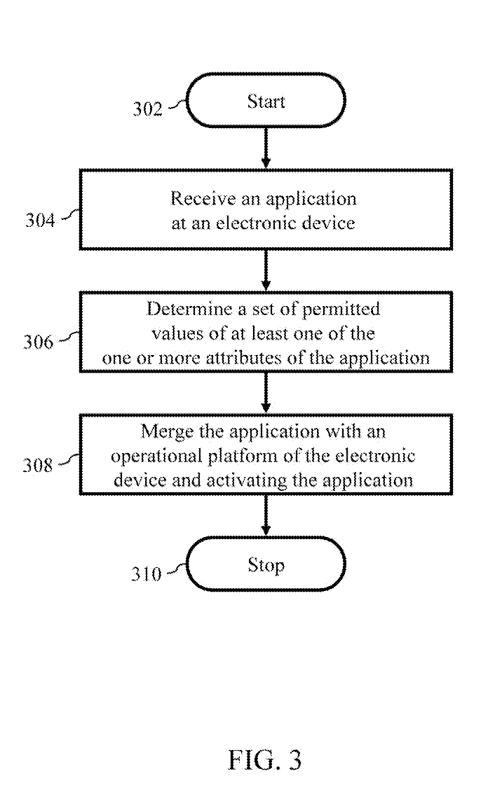

FIG. 3 is a flow diagram illustrating a method for managing applications at an electronic device 202, in accordance with an embodiment of the present invention. To explain the method for managing applications at an electronic device, references will be made to the FIG. 2. However, it will be apparent to a person ordinarily skilled in the art that the method can be implemented by using any other suitable embodiment of the present invention. Further, the method can be implemented by using a greater number of steps than shown in FIG. 3. Moreover, the invention is not limited to the order in which the steps are listed in the method.

The method for managing applications at the electronic device 202 is initiated at step 302. At step 304, an application is received at the electronic device 202. For example, when a user enters a restaurant, an application such as the price list application of the restaurant can be received at the electronic device 202 of a user. The application has one or more user interface attributes, which have a set of usable values. The price list application can have user interface attributes such as the format of the file, the font size of the text, the color of the text, and so forth. At step 306, a set of permitted values of at least one of the one or more user interface attributes is determined. The user interface attributes of the application at the electronic device 202 must adhere to the permitted values, to enable merging of the application at the electronic device 202. These permitted values are determined by using policy rules at the electronic device 202. The permitted values can be generated in response to one or more environmental conditions determined by the electronic device 202. At step 308, the application is merged with an operational platform of the electronic device 202. It is merged and activated at the electronic device 202 when there is at least one value that is common to the set of permitted values and the set of usable values of each of the at least one of the one or more user interface attributes of the application.

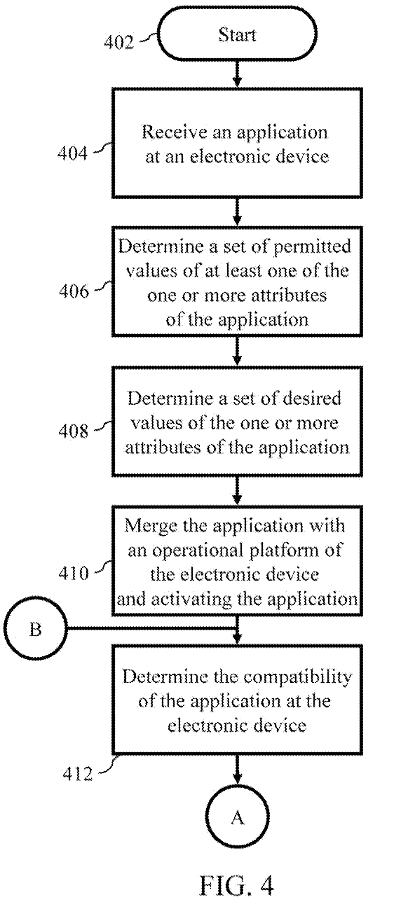

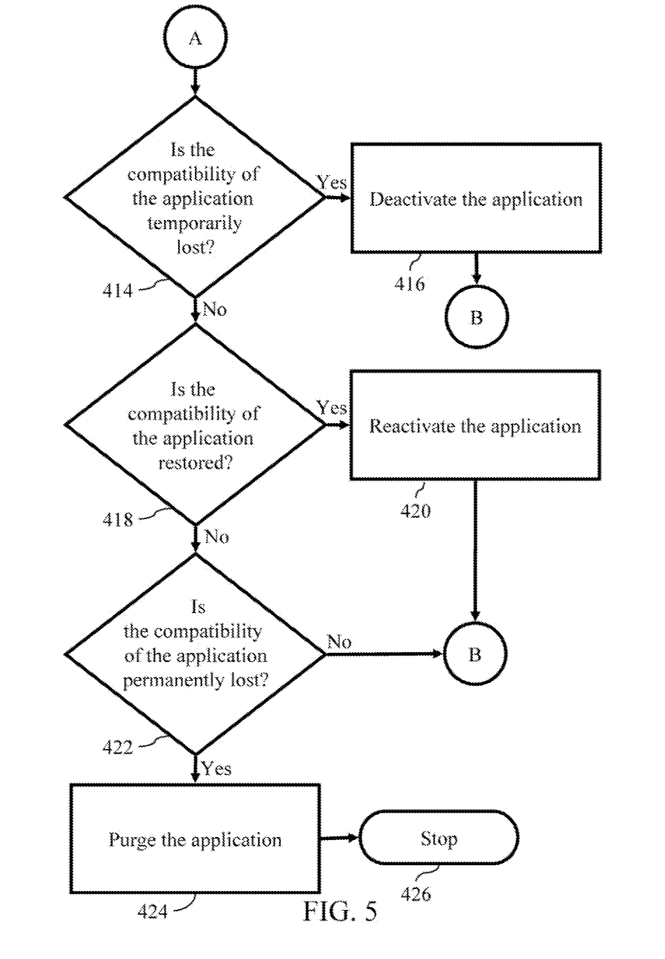

FIG. 4 is a flow diagram illustrating a method for managing applications at a electronic device 202, in accordance with another embodiment of the present invention. To explain the method for managing applications at the electronic device 202, references will be made to the FIG. 2. However, it will be apparent to a person ordinarily skilled in the art that the method can be implemented by using any other suitable embodiment of the present invention. Further, the method can be implemented by using a fewer or greater number of steps than shown in the FIG. 4. Moreover, the invention is not limited to the order in which the steps are listed in the method.

The method is initiated at step 402. At step 404, an application is received at the electronic device 202 by the receiver 204. This application has one or more user interface attributes. Each user interface attribute has a set of usable values. After step 404, step 406 is performed.

At step 406, a set of permitted values of at least one of the one or more user interface attributes of the application are determined by the processor 206 by using policy rules according to the environmental conditions determined by the electronic device 202.

Each policy rule can be from a source, such as legal, government, cultural or religious; a user's personal level of ethics or style, personality or practice, or commerce. In some embodiments, the source type may be a mix of one or more of the listed source types. Each policy rule may control one or more of several aspects of the merging, purging, activation, and deactivation of an application. Controlled aspects include times and locations at which applications may be merged, purged, activated, and deactivated. Specific examples include a certain time of day or certain duration of time, after the process of merging, when permanent purging or unmerging of an application should take place; locations where game applications are not allowed to be used; and locations in which recording applications are not allowed to be used; and locations in which audible sound generating applications are not allowed to be used.

The environmental conditions determined by the electronic device 202 can be one or more of the location of the electronic device 202, relevant to its geography, surroundings, political boundaries or sovereignty, enterprise ownership, and so forth. The environmental conditions of the electronic device 202 can also be its position, which is relevant to the user's body and the time of day at the electronic device 202. Further, the environmental conditions can be a user's personal identification or enterprise affiliation, and the goal the application is being used to achieve. Moreover, the environmental conditions can be the task for which the application is being used to complete, the power state of the electronic device 202, and the user's mental model of interaction to accomplish the task and achieve the goal. After step 406, step 408 is performed.

At step 408, a set of desired values of the one or more user interface attributes of the application is determined by the processor 206 by using the user inputs of the electronic device 202 as well as the user's historical profile of preferences. After step 408, step 410 is performed.

At step 410, the application is merged with an operational platform, such as an operating system, at the electronic device 202 by the processor 206, when there is a common value of the set of permitted values, the set of usable values, and the set of desired values. After step 410, step 412 is performed.

At step 412, the compatibility of the application that is merged at the electronic device 202 is checked by the processor 206. The compatibility of the application can be checked after a fixed interval of time by using the usable values, the permitted values and the desired values of the user interface attributes. After step 412, step 414 is performed.

At step 414, it is determined whether the compatibility of the application has been temporarily lost. When it is determined at step 414 that the compatibility of the application at the electronic device 202 has been temporarily lost, step 416 is performed. At step 416, the application is de-activated at the electronic device 202. Thereafter, step 412 is performed. When it is determined at step 414 that the compatibility of the application has not been temporarily lost, step 418 is performed.

At step 418, it is determined whether the compatibility of the application at the electronic device 202 has been restored. When it is determined at step 418 that the compatibility of the application has been restored, step 420 is followed. At step 420, the application is re-activated at the electronic device 202. Thereafter, step 412 is followed. When it is determined at step 418 that the compatibility of the application has not been restored, step 422 is performed.

At step 422, it is determined whether the compatibility of the application has been permanently lost. When it is determined at step 422 that the compatibility of the application has not been permanently lost, step 412 is followed. When it is determined at step 422 that the compatibility of the application has been permanently lost, step 424 is performed.

At step 424, the application is purged from the electronic device 202. Purging the application implies that it has been removed from the electronic device 202 and cannot be used. Thereafter, the method terminates at step 426.

The method is illustrated with reference to an example, for clarity. Consider a scenario where a customer enters a restaurant and he wants the price list application of the restaurant to be received on a electronic device 202 such as a PDA. This price list application can have user interface attributes such as its format and file size, the platform dependency of the application, the font of the text, and so forth. The user interface attributes of the price list application, such as its format type, can have a usable value such as ‘.txt.’, ‘.doc’, and so forth. The price list application of the restaurant that is received at the electronic device 202 will not be merged at the electronic device 202 before its compatibility is determined at the electronic device 202. To determine the compatibility of the price list application, the processor 206 at the electronic device 202 can determine the permitted values of its user interface attributes, for instance, the location of the price list application. The permitted values of the location attribute can be locations inside the restaurant. Therefore, the price list application can be merged with the electronic device 202 when its location matches the permitted values. Further, the user can specify the desired values of the user interface attributes, such as the font of the text of the price list application that should be allowed to enable merging at the electronic device 202. The price list application of the restaurant can be merged at the electronic device 202 when the font of the text matches the requirements of the user and the electronic device 202 is located inside the restaurant.

After the price list application is merged with the electronic device 202, its user interface attributes are continuously monitored and compared with the permitted and desired values of the user interface attributes of the application. When the user goes out of the restaurant, the location attribute of the price list application at the electronic device 202 may not match the permitted value of the location, and hence, it is de-activated at the electronic device 202. Further, when the user of the electronic device 202 re-enters the restaurant, its location attribute matches the permitted values of the location of the price list application of the restaurant. Hence, the price list application is re-activated at the electronic device 202. When the electronic device 202 goes away from the restaurant permanently, the price list application may be purged from the electronic device 202.

Various embodiments of the present invention offer one or more advantages. The applications received at the electronic device are checked for compatibility with user requirements and/or environmental conditions before the applications are merged at the electronic device. Only applications that are compatible are merged with the electronic devices. Incompatible applications are rejected at the electronic device. Moreover, the applications that are merged at the electronic devices are monitored at regular intervals to determine their compatibility with user requirements and/or environmental conditions at the electronic device. Further, the applications may be de-activated and/or purged from the electronic device when they become temporarily or permanently incompatible with the electronic device or the environment.

Implementation of the above functions may be facilitated in some embodiments using the tools provided, or tools similar to those provided, in standards such as those available from the OSGI™ Alliance, with particular reference to the life cycle layer description in the r4.1-final-core.pdf and http service in r4.1-companionservices.pdf, by using the tools of the standards or similar tools in unique combination with other uniquely arranged programming instructions in a processing system.

It will be appreciated that the method and system for managing applications at a electronic device, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, GPS receivers, power-source circuits, environmental or biological sensors and user-input devices. Therefore, these functions may be interpreted as steps of a method and system for managing applications at a electronic device. Alternatively, some or all the functions can be implemented by a state machine that has no stored program instructions, or in one or more application-specific integrated circuits (ASICs), in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing an application at an electronic device, the method comprising:
receiving at the electronic device the application, the application comprising one or more user interface attributes, each user interface attribute comprising a set of usable values;
determining a set of permitted values of at least one of the one or more user interface attributes using policy rules that make the determination in response to one or more environmental conditions determined by the electronic device; and
merging the application with an operational platform of the electronic device and activating the application when, for each of the at least one of the one or more user interface attributes of the application, there exists at least one value common to the set of permitted values and the set of usable values.

2. The method as recited in claim 1 further comprising determining a desired value of the one or more user interface attributes based on user inputs of the electronic device, wherein the application is merged with other applications when, for each of the at least one of the one or more user interface attributes of the application, there is at least one value common to the set of permitted values, the set of usable values, and the desired value.

3. The method as recited in claim 1 further comprising deactivating the application when compatibility is determined to be temporarily lost.

4. The method as recited in claim 3 further comprising reactivating the application when the compatibility is determined to be restored.

5. The method as recited in claim 1 further comprising purging the application when compatibility is determined to be permanently lost.

6. The method as recited in claim 1, wherein the one or more environmental conditions comprise at least one of:
location of the electronic device relevant to geography, surroundings, political boundaries or sovereignty, enterprise ownership;
position of the electronic device relevant to the user's body;
time of day at the electronic device;
user personal identification;
user's personal interaction preferences;
enterprise affiliation of the user;
goal for which the application is being used to achieve;
task for which the application is being used to complete;
power state of the electronic device; and
user's mental model of interaction to accomplish the task and achieve the goal.

7. The method as recited in claim 1, wherein each policy rule is of one or more of the source types: legal, government, cultural, religious, user's personal level of ethics, user's personal level of style, personality or practice, and commerce.

8. The method as recited in claim 1, wherein each policy rule controls at least one of a time or a location at which an application is merged, purged, activated or deactivated.

9. The method as recited in claim 1, wherein each policy rule controls at least one of:
a certain time of day or a certain duration after merging for purging of an application;
locations where game applications are deactivated;
locations in which recording applications are deactivated; and
locations in which all audible sound generating applications are deactivated.

10. An electronic device capable of managing an application, the electronic device comprising:
a receiver configured to receive the application, the application comprising one or more user interface attributes, each user interface attribute comprising a set of usable values; and
a processor configured to:
determine a set of permitted values of at least one of the one or more user interface attributes using policy rules that make the determination in response to one or more environmental conditions determined by the electronic device; and
merge the application with an operational platform of the electronic device and activating the application when, for each of the at least one of the one or more user interface attributes of the application, there exists at least one value common to the set of permitted values and the set of usable values.

11. The electronic device as recited in claim 10, wherein the processor is further configured to:
determine a desired value of the one or more user interface attributes based on user inputs of the electronic device, wherein the application is merged with other applications when, for each of the at least one of the one or more user interface s of the application, there is at least one value common to the set of permitted values, the set of usable values, and the desired value.

12. The electronic device as recited in claim 11, wherein the processor is further configured to:
deactivate the application when compatibility is determined to be temporarily lost;
reactivate the application when the compatibility is determined to be restored; and
purge the application when the compatibility is determined to be permanently lost.

13. The electronic device as recited in claim 10, wherein each policy rule is one or more of one of the source types: legal, government, cultural, religious, user's personal level of ethics, user's personal level of style, personality or practice, and commerce.

14. The electronic device as recited in claim 10, wherein each policy rule controls at least one of a time or a location at which an application is merged, purged, activated or deactivated.

15. The electronic device as recited in claim 10, wherein each policy rule controls at least one of:
a certain time of day or a certain duration after merging for purging of an application;
locations where game applications are deactivated;
locations in which recording applications are deactivated; and
locations in which all audible sound generating applications are deactivated
